(19) United States
(12) Patent Application Publication
(10) Pub. No.: US 2002/0037493 A1
(43) Pub. Date: Mar. 28, 2002

(54) Method for predicting the need for dose reductions in chemotherapy for patients with breast cancer: a potential decision aid for the use of myeloid growth factors

(76) Inventors: Panos Savvides, Boxford, MA (US); Norma Terrin, Jamaica Plain, MA (US); John Erban, Wakefield, MA (US); Harry Selker, Wellesley, MA (US)

Correspondence Address: ERIC L. PRAHL, Fish & Richardson P.C., 225 Franklin Street, Boston, MA, 02110-2804, US

(21) Appl. No.: 09/891,089

(22) Filed: Jun. 25, 2001

Related U.S. Application Data
(63) Continuation of application No. 09/686,578, filed on Oct. 11, 2000.
(60) Provisional application No. 60/158,776, filed on Oct. 12, 1999.

(51) Int. Cl. A01N 1/00

(52) U.S. Cl. 435/1.1

(57) ABSTRACT

The invention provides provided a method and instrument for predicting the probability of a patient requiring a significant dose reduction in adjuvant chemotherapy for breast cancer and/or predicting whether early treatment with a myeloid growth factor is warranted, by determining the patient's dose-adjusted nadir absolute neutrophil count (ANC) in the first cycle of the chemotherapy schedule, further determining the patient's dose-adjusted percent change in platelet count from day one to the dose-adjusted nadir platelet count in the first cycle of the chemotherapy schedule, and then calculating the probability that the patient will receive a suboptimal chemotherapy dose using the dose-adjusted nadir ANC and dose-adjusted percent change in platelet count.

### RELATED APPLICATIONS

This application claims priority to, and is a continuation of, U.S. Ser. No. 60/158,776, filed Oct. 12, 1999, the teachings of which are hereby incorporated by reference herein.

### FIELD OF THE INVENTION

The invention relates to predictive methods, generally, and more specifically to medical and therapeutic predictive methods.

### BACKGROUND OF THE INVENTION

Administration of adjuvant chemotherapy in women with breast cancer has been shown to improve both disease-free and overall survival (“Early Breast Cancer Trialist's Collaborative Group: Systemic treatment of early breast cancer by hormonal, systemic or immune therapy: 133 randomized trials involving 31,000 recurrences and 24,000 deaths among 75,000 women,” Lancet 339:1 (1992); Gelber et al., “Adjuvant therapy for breast cancer: Understanding the overview,” J. Clin. Oncol. 11:580-585 (1993); “Early Breast Cancer Trialist's Group: Polychemotherapy for early breast cancer: An overview of the randomized trials,” Lancet 352: 930 (1998); Norton, “Adjuvant Breast Cancer Therapy: Current status and future strategies—growth kinetics and the improved drug therapy of Breast Cancer,” Semin. Oncol. 26: S3 1-4 (1999)). Moreover, a recent prospective randomized trial showed that the doses of chemotherapy used to treat breast cancer should not be reduced if the maximal benefit is to be achieved. (Wood et al., “Dose and dose intensity of adjuvant chemotherapy for stage II, node-positive breast carcinoma,” N. Engl. J. Med. 330: 1253-1259 (1994)). These results suggest an important effect of chemotherapy dose within a narrow range, or that a “threshold” effect may exist for adjuvant systemic chemotherapy of breast cancer. In either case, dose reductions, can lead to decreased patient survival.

In clinical practice, chemotherapy dose reductions usually are due to excess toxicity, myelotoxicity being the most common. Therefore, there have been efforts to optimize delivery of the scheduled chemotherapy dose with the help of hematopoietic growth factors, in an attempt to decrease the incidence of myelotoxicity. However, the widespread clinical use of hematopoietic growth factors, such as granulocyte colony-stimulating-factor (G-CSF) and granulocyte-macrophage colony-stimulating-factor (GM-CSF), have not been shown to result in improvement of disease specific or overall survival rates when applied to all cancer patients. Accordingly, the routine use of hematopoietic growth factors with conventional chemotherapy is not recommended by the current evidence-based guidelines of the American Society of Clinical Oncology (ASCO), since they have not proven to be cost-effective in chemotherapy regimens where the expected incidence of febrile neutropenia is less than 40% (“American Society of Clinical Oncology Recommendations for the Use of Hematopoietic Colony-Stimulating Factors: Evidence-Based, Clinical Practice Guidelines,” J. Clin. Oncol. 12: 2471-2508 (date?); “Update of Recommendations for the Use of Hematopoietic Colony-Stimulating Factors: Evidence-Based Practice Guidelines,” J. Clin. Oncol. 14: 1957-1960 (1996)). Attempts to predict dose reductions based on first chemotherapy cycle observations have been limited, and have not yielded a statistically significant predictive method (Silber et al., “First-Cycle Blood Counts and Subsequent Neutropenia, Dose Reduction, or Delay in early-stage breast cancer therapy,” JCO 16: 2392-2400 (1998)).

Accordingly, there remains an urgent need for a method to identify those breast cancer patients whose probabilities of requiring a significant dose reduction of their scheduled chemotherapy are sufficiently high to warrant early treatment with a myeloid growth factor.

### SUMMARY OF THE INVENTION

In accordance with the present invention, there is provided a method for predicting the probability of a patient requiring a significant dose reduction in adjuvant chemotherapy for breast cancer and/or predicting whether early treatment with a myeloid growth factor is warranted, by determining the patient's dose-adjusted nadir absolute neutrophil count (ANC) in the first cycle of the chemotherapy schedule, further determining the patient's dose-adjusted percent change in platelet count from day one to the dose-adjusted nadir platelet count in the first cycle of the chemotherapy schedule, and then calculating the probability that the patient will receive a suboptimal chemotherapy dose using the dose-adjusted nadir ANC and dose-adjusted percent change in platelet count. In one embodiment of the method, the dose reduction is necessitated by excess myelotoxicity.

In a preferred embodiment of the method, the dose-adjusted nadir ANC is determined by the following calculation: (observed nadir white blood cell (WBC) count)×(% of planned chemotherapy dose actually administered in the first cycle), where the planned chemotherapy dose is the sum of all individual chemotherapeutic drug doses planned. In another preferred embodiment of the method, the dose-adjusted percent change in platelet count of step (b) is determined by the following calculation: (((platelet count on day 1 of the first cycle)−(dose-adjusted nadir platelet count in the first cycle)) / (observed platelet count on day 1 of the first cycle))×100, where the dose-adjusted nadir platelet count is calculated as: (observed nadir platelet count in the first cycle)×(% of planned chemotherapy dose actually administered in the first cycle), and where the planned chemotherapy dose is the sum of all individual chemotherapeutic drug doses planned.

In a further preferred embodiment of the method, the probability that a patient will receive a suboptimal chemotherapy dose is calculated as: 1/(1+exp^{-(0.28-1.97×(dose-adjusted nadir ANC in said first cycle)+0.04×(dose-adjusted percent change in platelet count in said first cycle))}), where a “suboptimal” chemotherapy dose is defined as less than about 85% of the planned chemotherapy dose, the planned chemotherapy being the sum of all individual chemotherapeutic drug doses planned.

In yet another preferred embodiment of the method, the adjuvant chemotherapy comprises administering cyclophosphamide, doxorubicin, and 5-fluorouracil (CAF chemotherapy), and the chemotherapy schedule comprises six 28-day cycles of CAF chemotherapy, where each cycle comprises administering 100 mg/m²/day of cyclophosphamide on days 1 through 14, administering 30 mg/m²/day of doxorubicin on days 1 and 8, and administering 500 mg/m²/day of 5-fluorouracil on days 1 and 8.

The invention also provides an instrument for predicting the probability of a patient requiring a significant dose reduction in adjuvant chemotherapy for breast cancer and/or predicting whether early treatment with a myeloid growth factor is warranted, the instrument comprising a means for calculating the probability that said patient will receive a suboptimal chemotherapy dose, where a “suboptimal” chemotherapy dose is defined as less than about 85% of the planned chemotherapy dose. In a preferred embodiment, the probability is calculated as: 1/( 1+exp^{-(0.28-1.97×(dose-adjusted nadir ANC in the first cycle of said patient's chemotherapy schedule)+0.04×(dose-adjusted percent change in platelet count from day one to the dose-adjusted nadir platelet count in said first cycle of said patient's chemotherapy schedule))}), where the dose-adjusted nadir ANC and dose-adjusted percent change in platelet count are calculated as described above. In one embodiment, the instrument is hand-held, and the calculations are performed using a suitably programmed central processing unit.

The method and instrument of the invention will provide clinicians with a way to select patients who might benefit from myeloid growth factors to avoid the need for dose reductions or delays in future cycles, and will assist in improving adjuvant chemotherapy outcomes and the appropriate use of myeloid growth factors.

### BRIEF DESCRIPTION OF THE DRAWINGS

FIG. 1—is a bar graph depicting the percent of patients receiving suboptimal chemotherapy doses over a six-cycle schedule: by specific chemotherapeutic drug (FIG. 1A) and by sum of all chemotherapeutic drugs (FIG. 1B).

FIG. 2—is a graph depicting the statistical performance, by Receiver-Operating Performance (ROC) of the predictive method of the invention.

FIG. 3—is a bar graph depicting the calibration of the method of the invention, comparing predicted suboptimal chemotherapy doses versus observed suboptimal chemotherapy doses.

FIG. 4—is a contour graph depicting predicted probabilities of suboptimal chemotherapy doses using the method of the invention.

### DETAILED DESCRIPTION OF THE INVETION

The invention provides a method for predicting the probability of a patient requiring a significant dose reduction in adjuvant chemotherapy for breast cancer and/or predicting whether early treatment with a myeloid growth factor is warranted, by determining the patient's dose-adjusted nadir absolute neutrophil count (ANC) in the first cycle of the chemotherapy schedule, further determining the patient's dose-adjusted percent change in platelet count from day one to the dose-adjusted nadir platelet count in the first cycle of the chemotherapy schedule, and then calculating the probability that the patient will receive a suboptimal chemotherapy dose using the dose-adjusted nadir ANC and dose-adjusted percent change in platelet count.

The method is based on the analysis of data from a recent phase III clinical trial (Fetting et al., “Sixteen-Week Multidrug regimen versus cyclophoshamide, doxorubicin, and fluorouracil as adjuvant therapy for node-positive, receptor-negative breast cancer: An Intergroup study,” J. Clin. Oncol. 16: 2382-2391 (1988)). Data on 323 women who had lymph node-positive hormone-receptor negative breast cancer treated with cyclophosphamide, doxorubicin and fluorouracil (CAF chemotherapy) for a total of 6 cycles in a phase III intergroup clinical trial were retrospectively analyzed. Based on data from treatment cycle 1, a logistic regression was generated that predicts a patient's probability of requiring significant reduction of chemotherapy, i.e. a “suboptimal” chemotherapy dose, which is defined herein as receiving about 85% or less of the planned chemotherapy dose over cycles 2 through 6. The “planned chemotherapy dose” is the sum of all individual chemotherapeutic drug doses planned.

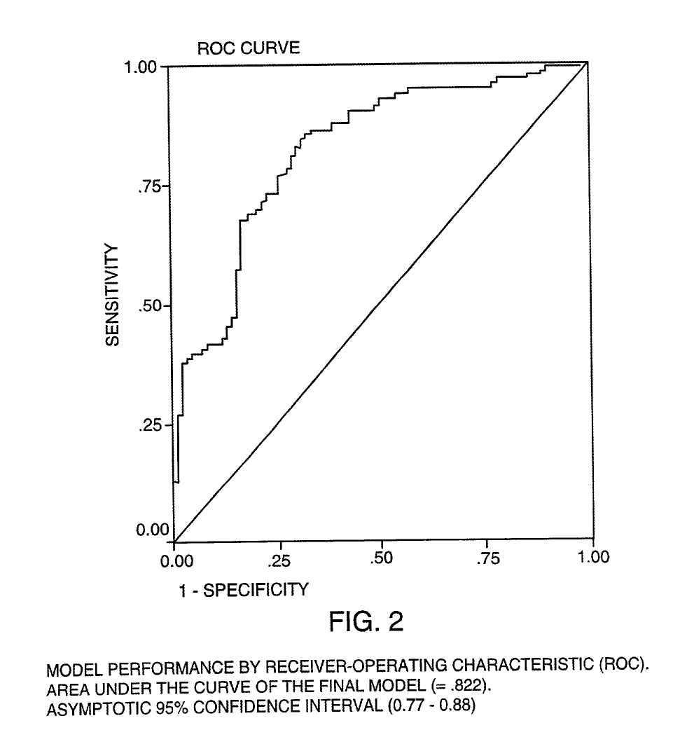

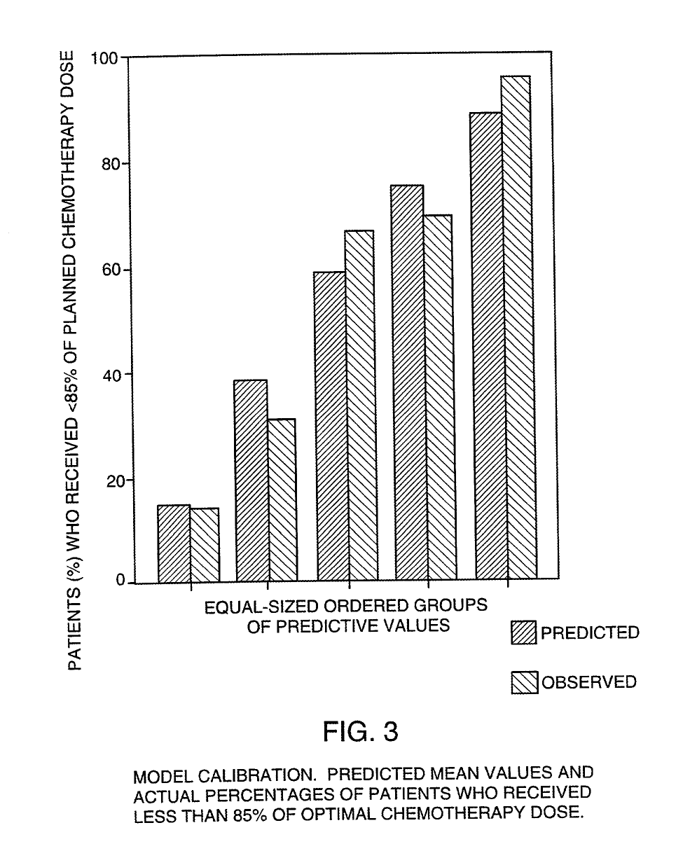

The regression model generated, which predicts CAF chemotherapy dose reduction, included as its variables the absolute neutrophil count in cycle 1 and the percent change of platelets between day 1 and the nadir in cycle I, with both variables being dose-adjusted, based on the chemotherapy dose actually delivered in cycle 1, as further discussed below. The model has a good discriminatory performance (ROC area=0.82; see FIG. 2) and good calibration of its predictions with actual rates of CAF dose reductions across all levels of severity (see FIG. 3).

Patient Group

Data were analyzed for 323 patients who received standard dose cyclophosphamide, doxorubicin and 5-fluorouracil (CAF) chemotherapy, with no myeloid growth factor support, in a phase III intergroup clinical trial comparison of Cyclophosphamide, Doxorubicin, and 5-Fluorouracil (CAF) and a 16-Week Multi-Drug Regimen as Adjuvant Therapy for Patients with Hormone Receptor Negative, Node-Positive Breast Cancer (EST 3189, SWOG 8931, INT 0108), coordinated by the Eastern Cooperative Oncology Group (ECOG) (see Fetting et al., supra). These patients were diagnosed with T₁₋₃ invasive breast cancer, one or more pathologically involved lymph nodes, negative for estrogen and progesterone receptors, with no evidence of distant metastases or involvement of the other breast. Primary (surgical) therapy consisted of modified radical mastectomy or breast-conserving surgery. Patients who received less than total mastectomy received postoperative radiotherapy either before, or within, 4 weeks from the last dose of chemotherapy. Of the 323 patients, data were not analyzed for 30 patients because they did not complete the assigned therapy (reasons for not completing treatment: death, 3; progression or relapse, 3; contraindications due to complications or toxicity, 8; patient refusal due to complications or toxicity, 7; patient refusal for other reasons, 4; and reason not available, 5) and 5 were excluded because doxorubicin was substituted by methotrexate due to cardiac toxicity.

Chemotherapy Protocol

The patients analyzed, randomized to CAF chemotherapy, were scheduled to receive six 28-day cycles of CAF-chemotherapy on the following schedule for each cycle: cyclophosphamide, 100 mg/m²/day, on days 1 through 14; doxorubicin, 30 mg/m²/day, on days 1 and 8; and 5-fluorouracil (5-FU), 500 mg/m²/day, on days 1 and 8.

The algorithm utilized in the invention for dose modifications based on hematologic toxicities was as follows: Therapy was delayed up to two weeks if the granulocyte count on day 1 of each cycle was less than 2,000/μL or if the platelet count was less than 100,000/μL. If counts continued to be low even after two weeks, then a day-8 (of each cycle) dose modification algorithm was used as follows: Chemotherapy dose was reduced by 25% for an absolute neutrophil count (ANC) count of 1500 to 1999 and a platelet count of more than 100,000; by 50% for an ANC count of 1,000 to 1,499 and a platelet count of more than 100,000/μL, or an ANC count of 1,000 to 1,999 and a platelet count of 50,000 to 99,000/μL. Chemotherapy was not administered on day 8 if the ANC count was less than 1,000//μL or the platelet count was less than 50,000/μL.

Chemotherapy doses were reduced by 25% if, during the previous cycle, the patient developed neutropenic fever or sepsis, or if the ANC decreased to less than 500/μL. For grade 3 or 4 mucositis, 5-FU and doxorubicin doses were reduced by 25% in subsequent cycles, and if mucositis did not recur, doses could be escalated by 10% per cycle up to ideal (i.e. scheduled) doses.

Data Analysis

Data from the original trial (see Fetting et al., supra) analyzed included patient demographic characteristics, disease staging information, treatment prior to chemotherapy (surgery, radiation therapy), and, for the period of chemotherapy administration, dose of each drug, and complete blood counts (CBC), including values for the four primary variables: hemoglobin, platelets, white blood cells (WBC), and percent of neutrophils and bands on days 1, 8 and nadir (defined in the original trial as any day between day 15 to 22) of each cycle. The dates of chemotherapy administration were recorded so that the cycle duration could be calculated.

In addition, secondary variables derived from the four primary variables were calculated, representing the following information: 1) absolute number of neutrophils (ANC, defined as the product of WBC×percent of neutrophils and bands); 2) the difference between chemotherapy day 1 and nadir value for ANC and all four primary variables; and 3) the percent change between chemotherapy day 1 and nadir values for ANC and all four primary variables.

Data for the dose of each chemotherapeutic drug (in mg/m²) were available. The percentage of the planned doses of each of the 3 drugs actually delivered during chemotherapy cycle one were highly correlated and were averaged to create a new variable. Furthermore, since the day 8 and nadir counts depend on the chemotherapy dose actually delivered, new variables were created by multiplying the observed hematologic values with the percentage of chemotherapy actually delivered, to adjust for dose modifications.

As used herein, delivery of a “suboptimal chemotherapy dose” is defined as delivery of less than 85% of the protocol's planned total dose (i.e. the sum of all individual chemotherapeutic drug doses planned) over chemotherapy cycles 2 through 6 (data from the first cycle were used to predict subsequent dose reductions). The 85% cutoff point was selected because a number of retrospective analyses have shown improved rates of relapse-free and overall survival in the subgroup of patients who received at least 85% of the planned dose of conventional chemotherapy regimens (Bonadonna et al., “Adjuvant cyclophosphamide, methotrexate, and fluorouracil in node-positive breast carcinoma,” N. Engl. J Med. 332: 901-906 (1995); Bonadonna et al., “Dose response effect of adjuvant chemotherapy in breast cancer,” N. Engl. J Med. 304: 10-15 (1981). Alternatively, a higher cutoff, e.g. 90% of the planned dose, may be selected.

Also as used herein, the “percentage of planned chemotherapy dose” (or “% of planned chemotherapy dose”) is calculated as follows: For each patient, the total administered dose over cycles 2 through 6 of each of the three chemotherapeutic drugs was calculated. For each drug, the total dose administered was divided by the total protocol-based planned dose. The percentage of planned chemotherapy dose received represents the average of all three drugs given. If the overall percentage over cycles 2 through 6 is less than 85%, this is coded as a suboptimal chemotherapy dose event.

Dose delays are not included in the definition of outcomes for two reasons: First, attempts to improve results by increasing the dose density of the same drugs have not yet resulted in clearly improved clinical outcomes (Wood et al., supra.; Hudis et al., “High-Dose therapy for Breast Cancer,” Semin. Oncol. 26: 35-47 (1999); Gradishar, “Recently initiated studies: Neoadjuvant treatments in the next century,” Semin. Oncol. 26: S3: 26-29 (1999); Münster et al., “Adjuvant therapy for resectable breast cancer,” Hematol. Oncol. Clin. North America 13: 391-413 (1999)). Second, although the concept of delivery of chemotherapy in a timely fashion is widely accepted, the selection of a threshold for delays in treatment beyond which clinical results are compromised is not clear. Surrogate markers of chemotherapy-associated toxicity are not included the definition of events since their association with clinical endpoints would be uncertain and their utility is questionable.

Statistical Methods

The method of the invention is based on pretreatment characteristics and information available during the first cycle of chemotherapy. The logistic regression model was constructed with the use of SPSS software (SPSS statistical analysis and data management system (version 9.0), SPSS, Inc., Chicago, Ill.). The existence of nonlinear terms was evaluated by generalized additive spline models in S-Plus (S-Plus data analysis system (version 4.5), MathSoft, Inc., Seattle, Wash.). The significance of variables included in the final logistic regression model reflects the results of the two-sided Wald statistic (Hosmer et al., APPLIED LOGISTIC REGRESSION, pp. 16-17, Wiley, New York, N.Y. (1989). Alternatively, other equivalent statistical methods or software familiar to those of skill in the art may be suitably employed.

The performance of the final logistic regression model was evaluated in two ways; by the area under the receiver-operating characteristic (ROC) curve (see FIG. 2), and by calibration of predicted with actual clinical outcomes (see FIG. 3). The former provides a measure of a prediction's diagnostic performance, and the latter an evaluation of accuracy of predictions across different levels of clinical severity.

Missing data are treated as follows: for patients with available white blood cell counts during cycle 1, but with the percent of neutrophils and bands missing (42 patients in the group analyzed), the nadir ANC of cycle 1 is calculated as follows: [ANC_{(nadir, cycle 1)}]=−0.388+0.198×[WBC_{(nadir, cycle)}]+0.078×[WBC_{(nadir,cycle1)}]²+0.736×[% Neutrophils_{(day1, cycle1)}]. The linear regression equation based on 210 patients with complete data had an R-square of 75% and was used to impute the missing ANC nadir values. For patients whose nadir cell counts (WBC, neutrophils, Hgb and Platelets) are not available (36 patients in the group analyzed), no imputed values are used; for the patient group analyzed, linear regression models, using a similar technique as described above, had a R-square of approximately 50%, and were not adequate for imputing missing nadir ANC and platelet values.

In accordance with the invention, predictive models based on complete cases (n=210) and on eligible cases with the addition of the 42 cases with imputed values (n=252) were developed. Patients who completed chemotherapy and patients with complete records did not differ in the demographic characteristics or laboratory values from the group of eligible patients (see Table I). Furthermore, the model developed with the additional imputed values did not differ in the variables selected and performed comparably (Receiver-Operating Characteristic Curve: 0.80) to the model based on complete cases. The predictive method and model based on the 210 patients on whom complete data were available is described in more detail in Example 1, below.

TABLE 1
Patient demographic, disease staging and laboratory characteristics.

| | | Patients who completed | |
|---|---|---|---|
| | All patients | chemotherapy treatment | Complete |
| | (N = 323) | (N = 288) | cases (N = 210) |
| Age, years | | | |
| Median | 47.4 | 47.5 | 47.3 |
| Range | 26-79 | 27-78 | 27-78 |
| Performance status | | | |
| 0 | 297 (92) | 265 (92) | 192 (91) |
| 1 | 25(8) | 23(8) | 18(9) |
| 2 | 1 | | |
| Race | | | |
| White | 252 (78) | 231 (80) | 167 (80) |
| Black | 50 (15) | 40 (14) | 30 (14) |
| Other | 19 (6) | 15 (5) | 11(5) |
| Missing | 2(1) | 2(1) | 2(1) |
| Tumor size | | | |
| <2 cm | 72 (22) | 65 (23) | 51(24) |
| 2-5 cm 186 (58) | 166 (58) | | 116 (55) |
| >5 cm | 65 (20) | 57 (20) | 43 (21) |
| Number of positive lymph | | | |
| nodes | | | |
| 1-3 | 171 (53) | 156(54) | 119 (57) |
| 4-9 | 102 (32) | 90 (31) | 61(29) |
| ≧10 | 49(15) | 42(15) | 30(14) |
| Missing | 1 | | |
| Days from surgery | 35 ± 15 | 35 ± 14 | 36 ± 14 |
| Radiation therapy* | | | |
| Post-chemotherapy | 315 (97) | 281 (98) | 205 (98) |
| Pre-chemotherapy | 8 (3) | 7 (2) | 5 (2) |
| Laboratory values | | | |
| Hgb day 1 cycle 1 (g/L) | 12.52 ± 1.28 | 12.56 ± 1.28 | 12.56 ± 1.22 |
| WBC day 1 cycle 1 (10³/dL) | 6.93 ± 1.81 | 7 ± 1.82 | 7 ± 1.77 |
| Neutrophils day 1 cycle 1 (%) | 0.61 ± 0.10 | 0.61 ± 0.10 | 0.61 ± 0.10 |
| ANC day 1 cycle 1 (10³/dL) | 4.26 ± 1.54 | 4.33 ± 1.56 | 4.31 ± 1.44 |
| Platelet day 1 cycle 1 (10³/dL) | 318 ± 86 | 315 ± 85 | 318 ± 84 |
| Hgb nadir cycle 1 | 11.15 ± 1.15 | 11.18 ± 1.11 | 11.24 ± 1.15 |
| WBC nadir cycle 1 (10³/dL) | 1.81 ± 1 | 1.84 ± 1 | 1.84 ± 0.98 |
| Neutrophils nadir cycle 1 (%) | 0.39 ± 0.18 | 0.39 ± 0.18 | 0.39 ± 0.18 |
| ANC nadir cycle 1 (10³/dL) | 0.76 ± 0.68 | 0.76 ± 0.68 | 0.76 ± 0.68 |
| Platelet nadir cycle 1 (10³/dL) | 204 ± 84 | 205 ± 84 | 207 ± 84 |

Although a first chemotherapy cycle methodological approach has been reported by Silber et al. (see supra.), the present invention differs from the Silber et al. approach in several important ways. First, data used in the present analysis come from a large, multicenter, phase III clinical trial, as opposed to a single center, and hence are more statistically significant. Second, all of the patients in the present analysis group were treated on the same chemotherapy protocol (and therefore the same toxicity profile), using the same algorithm for dose reductions and cycle prolongation, as opposed to the patients included in the Silber et al. analysis, who were treated on chemotherapy regimens with different toxicity profiles, cycle durations, and number of days to expected nadir. Third, the definition of events in (e.g. suboptimal chemotherapy dose) in the present analysis is based solely on the observed total chemotherapy dose, instead of a mixture of events as in Silber et al. Accordingly, the method of the present invention provides a novel approach to predicting the need chemotherapy dose reductions using a unique, regressed algorithm which is statistically significant.

Using variables adjusted for dose improves results compared to simply using unadjusted values. Furthermore, this simple dose-adjustment of observed nadir hematologic values, is biologically plausible and conceptually rational for three reasons. First, the underlying assumption of a linear relationship between percentage of optimal dose delivered and hematologic toxicity observed through the laboratory values has been used successfully to predict nadir hematologic values (Bastholt et al., “Dose-response relationship of Epirubicin in the treatment of postmenopausal patients with metastatic breast cancer: A randomized study of Epirubicin at four different dose levels performed by the Danish Breast Cancer Cooperative Group,” JCO 14: 1146-1155 (1996)). Second, these new dose-adjusted variables are very highly correlated with the observed hematologic nadir values, given the fact that in more than 90% of patients analyzed, the delivered chemotherapy was within 10% of the planned dose. Finally, models developed without the dose-adjustment of nadir values selected were similar to the one described herein (see Example I) and performed comparably (ROC-curve: 0.80) with the model based on dose-adjusted values.

The method and instrument of the invention will facilitate real-time estimation of a given patient's risk of receiving substantially reduced chemotherapy. Development of this predictive method has important implications for both outcomes and supportive cancer care expenses. First, dose reductions in the adjuvant breast cancer setting result in increased mortality (see Wood et al., supra). Second, over 1 billion dollars is spent annually on utilizing colony-stimulating factors to support chemotherapy (see e.g., Amgen, Inc., 1998 Annual Report (Http://www.amgen. com/investor/AnnualReport); Immunex Corporation, 1998 Annual Report (Http://www. immunex.com/investor/HTML/redefault.html).

Currently, recommendations for use of myeloid growth factors are based on the underlying assumption that the same intervention will be applied to all patients scheduled to receive the same chemotherapy regimen. With the availability of a patient-specific real-time predictive instrument, more precise estimates of an individual's risk are feasible. Using such a clinical decision aid, prior to actually sustaining the hematologic toxicity that would mandate dose reductions in chemotherapy, one could selectively target the patients most likely to benefit from an intervention to prevent neutropenia, the major dose-limiting toxicity in the CAF regimen, by administering the appropriate supportive care only to that subgroup. With such an approach, in the case of myeloid growth factors such as G-CSF and GM-CSF, chemotherapy outcomes could improve (see Selker et al., “Use of the acute cardiac ischemia time-insensitive predictive instrument (ACI-TIPI) to assist with triage of patients with chest pain or other symptoms suggestive of acute cardiac ischemia. A multicenter, controlled clinical trial,” Ann. Int. Med. 129: 845-55 (1988)) by decreasing the incidence of chemotherapy-associated severe neutropenia and the need to reduce the planned chemotherapy dose.

Improved chemotherapy delivery is likely to be associated with improved survival outcomes. In specialties other than Oncology, logistic regression based predictive instruments have been developed and prospectively evaluated, and have been shown to aid physicians in real-time decisions, resulting in more efficient allocation of resources (Kaushansky, “Drug Therapy: Thrombopoietin,” N. Engl. J. Med. 339: 746-754 (1998); Pozen et al., “A predictive instrument to improve coronary-care-unit admission practices in acute ischemic heart disease,” N. Engl. J. Med. 310: 1273-1278 (1984); Selker et al., “Patient-specific predictions of outcomes in myocardial infarction for real-time emergency use: A thrombolytic predictive instrument,” Ann. Int. Med. 127: 538-556 (1997)).

A further description of the method of the invention, and its advantages, is provided by way of example, below. This example is not intended to limit the invention, except as provided in the claims appended hereto. Alternative methods (e.g. statistical software) equivalent to those employed in the development of the method of the invention and known to those of skill in the art are within the scope of the invention described herein. All cited references are hereby incorporated by reference herein.

### EXAMPLE 1

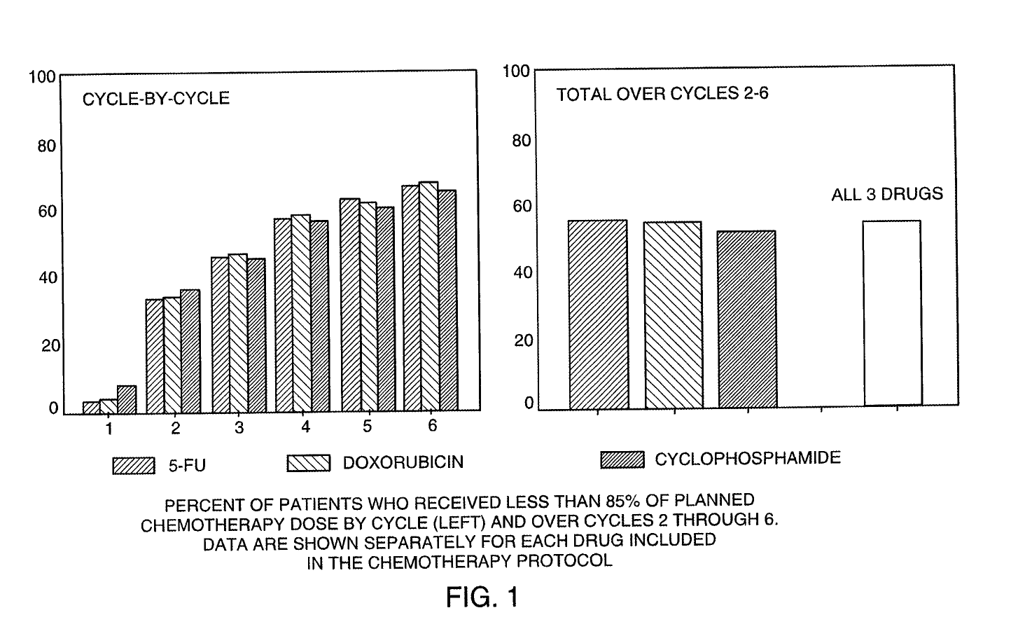

Patient demographic, disease specific and laboratory information on the patients analyzed in developing the method of the invention are presented in Table 1, supra. Among patients included in the analysis, 116 (55%) received less than 85% of the planned chemotherapy dose (i.e. a suboptimal chemotherapy dose). The percentage of patients who received less than 85% for each of the chemotherapy agents increased with each successive chemotherapy cycle, as shown in FIG. 1, and, as a result, this was also the case for the overall mean delivered chemotherapy dose. Demographic characteristics and disease staging information of the patients including age, performance status, type of surgery, time from surgery, pre-chemotherapy radiation therapy, primary tumor size, and number of positive axillary lymph nodes were not significant predictors of dose reduction.

Quantitative values of hematologic parameters (WBC, ANC, Platelets, Hgb) reached statistical significance even at their pretreatment levels and their prognostic significance increased with day 8 and nadir values. Statistical significance was further increased when hematologic nadir variables were dose-adjusted to reflect the percentage of chemotherapy actually delivered and calculated, as described above.

Predictive Method Regression Model

All available variables found to be statistically significant at the p≦0.05 level in univariate analyses were evaluated by stepwise multivariable logistic regression. Variables which were included in the final model were those which were statistically significant at the p≦0.05 level:

1) dose-adjusted nadir ANC in the first cycle of the chemotherapy schedule (cycle 1) (in 10³/dL), (OR: 0.14, 95% CI: 0.06 to 0.30, p<0.001) calculated as follows:

“nadir ANC”=[observed nadir WBC]×[% of planned dose actually delivered]

(Allowed range of values: 0-2, recorded to the nearest allowed value if outside the specified range); and

2) dose-adjusted percent change in platelet count (OR: 1.04, 95% CI: 1.02 to 1.05, p<0.001), defined as the % change in platelet count from day 1 to the nadir in the first cycle of the chemotherapy schedule (cycle 1) and calculated as follows:

$$“ \% platelet change ” = \frac{\begin{matrix}( [ Platelet count on day 1 ] - \\ [ dose \text{-} adjusted nadir Platelet count ] )\end{matrix}}{( [ observed Platelet count on day 1 ]} \times 100$$

where day 1 and nadir counts are in the first cycle of the chemotherapy schedule, and where:

“dose-adjusted nadir platelet count”=

[observed nadir platelet count]×[% planned chemotherapy dose actually delivered]

(Allowed range of values: 0-100, recorded to the nearest allowed value if outside the specified range.

The predictive instrument for the need for dose reductions in CAF-adjuvant chemotherapy for patients with breast cancer uses the logistic regression equation, which predicts the 1% to 100% probability of dose reduction. The definitions, coefficients, standard errors, 95% confidence intervals and p-values for the variables included in the final model method are as follows:

| | | Standard | | |
|---|---|---|---|---|
| Variable. | Coefficient | Error | 95% CI for e˜ | p-value |
| Nadir ANC | −1.97 | 0.39 | 0.06-0.30 | <0.001 |
| % Platelet Change | 0.04 | 0.01 | 1.02-1.05 | <0.001 |
| Intercept | 0.28 | | | |

where:

| | | |
|---|---|---|
| Outcome | | |
| “dose reduction” | =1, | if total dose actually delivered over cycles 2 through 6 is less than |
| | | 85% of the planned dose |
| | =0, | if total dose actually delivered over cycles 2 through 6 is equal to |
| | | or more than 85% of the planned dose |

Based on this regression, the probability (p) of an individual patient receiving a suboptimal chemotherapy dose can be calculated by the formula:

p=1/(1+exp^{-(0.28-1.97×[nadir ANC]+0.04×[% Pit change])}).

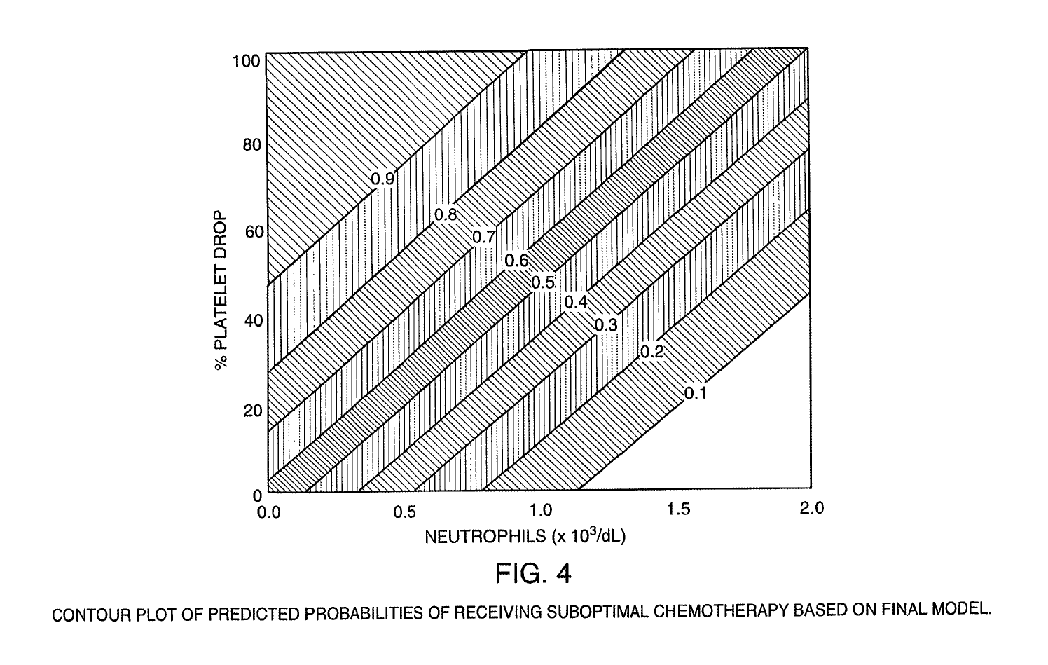

The predictive model and method of the invention has a good discriminatory performance (ROC area=0.82) (see FIG. 2), and is well calibrated across all levels of severity (see FIG. 3). The contour plot of FIG. 4 illustrates predicting the probability of a patient requiring a significant dose reduction in adjuvant chemotherapy for breast cancer and/or predicting whether early treatment with a myeloid growth factor is warranted using the method of the invention.

In the final model, nadir ANC, not nadir WBC, was included. While WBC and ANC variables are highly correlated, nadir ANC was a better predictor based upon the data analyzed. This selection comports with most published reports, although there have been sporadic reports suggesting that prior chemotherapy treatment and/or radiation therapy might alter these findings (Dumez et al., Abstract, “Predictors of dose and dose-intensity in adjuvant CMF with or without concomitant radiotherapy in node positive breast cancer,” J. Clin. Oncol. 18: 93a (1999)). The second variable included in the model, the percent platelet change between day 1 and the nadir (of the first cycle of chemotherapy), was found to be an important predictor. Although the importance of this variable was not anticipated before the data analysis was undertaken, it is believed that it reflects the more complicated regulation of the number of circulating platelets (see Kaushansky, supra.), and it is anticipated that it will prove useful in future modeling attempts addressing issues of chemotherapy toxicity. One could also envision that the use of the specific predictions provided by this model could be used as a basis for improved communication among oncologists, patients, and providers in developing a consensus on those patients who should be receiving myeloid growth factors, such as G-CSF and GM-CSF (Selker, “Systems for comparing actual and predicted mortality rates: Characteristics to promote cooperation in improving hospital care,” Ann. Int. Med. 118: 820-822 (1993)).

The predictive method described herein utilizes variables that are biologically reasonable and makes predictions that reflect their respective importance, as demonstrated by FIG. 4. For example, a patient with a platelet drop of 40% between day I and the nadir during the first cycle of chemotherapy can have a predicted risk of requiring substantial chemotherapy dose-reductions over the remaining 5 cycles (cycles 2 through 6) that can widely range from less than 10%, if the nadir ANC count was 2,000 to 45% if the ANC count was 1,000 to more than 70% if the ANC count falls below 500. Variables selected for the final predictive model are statistically significant, biologically important and easily measured. It is well documented that myeloid and megakaryocytic effects are the first hematologic toxicities reflected in the peripheral blood counts, as opposed to erythroid (as evidenced by the number of red blood cells and hemoglobin levels) toxicity which becomes evident later in the course of chemotherapy (Hoagland, “Hematologic complications of cancer chemotherapy,” in THE CHEMOTHERAPY SOURCEBOOK, pp. 498-507, MC Perry, ed., Williams and Wilkins, Baltimore, Md. (1992).

The predictive method described herein may be further validated using a different dataset, or may be evaluated in a prospective randomized clinical trial. In addition, future efforts will evaluate the applicability of the modeling approach described herein to other chemotherapy protocols with different toxicity profiles, used in patients with breast cancer and other chemo-sensitive malignancies.

What is claimed is:

1. A method for predicting the probability of a patient requiring a significant dose reduction in adjuvant chemotherapy for breast cancer and/or predicting whether early treatment with a myeloid growth factor is warranted, said method comprising the steps of:
(a) determining said patient's dose-adjusted nadir absolute neutrophil count (ANC) in the first cycle of said patient's chemotherapy schedule;
(b) determining said patient's dose-adjusted percent change in platelet count from day one to the dose-adjusted nadir platelet count in said first cycle of said patient's chemotherapy schedule; and
(c) calculating the probability that said patient will receive a suboptimal chemotherapy dose using said dose-adjusted nadir ANC and said dose-adjusted percent change in platelet count.

2. The method of claim 1, wherein said dose-adjusted nadir ANC of step (a) is determined by the following calculation: (observed nadir white blood cell (WBC) count)×(% of planned chemotherapy dose actually administered in said first cycle).

3. The method of claim 2, wherein said dose-adjusted percent change in platelet count of step (b) is determined by the following calculation: (((platelet count on day 1 of said first cycle)−(dose-adjusted nadir platelet count in said first cycle)) / (observed platelet count on day 1 of said first cycle))×100, wherein said dose-adjusted nadir platelet count is calculated as: (observed nadir platelet count in said first cycle)×(% of planned chemotherapy dose actually administered in said first cycle).

4. The method of claim 3, wherein said probability of step (c) is calculated as: 1/(1+exp^{-(0.28-1.97×(dose-adjusted nadir ANC in said first cycle)+0.04×(dose-adjusted percent change in platelet count in said first cycle))}).

5. The method of claim 1, wherein said suboptimal chemotherapy dose comprises less than about 85% of the planned chemotherapy dose.

6. The method of claim 1, wherein said adjuvant chemotherapy comprises administration of cyclophosphamide, doxorubicin, and 5-fluorouracil (CAF chemotherapy).

7. The method of claim 6, wherein said chemotherapy schedule comprises six 28-day cycles of CAF chemotherapy.

8. The method of claim 7, wherein each of said cycles of CAF chemotherapy comprises administration of 100 mg/m²/day of cyclophosphamide on days 1 through 14, administration of 30 mg/m²/day of doxorubicin on days 1 and 8, and administration of 500 mg/m²/day of 5-fluorouracil on days 1 and 8.

9. The method of claim 1, wherein said dose reduction is necessitated by excess myelotoxicity.

10. A method for predicting the probability of a patient requiring a significant dose reduction in adjuvant chemotherapy for breast cancer and/or predicting whether early treatment with a myeloid growth factor is warranted, said method comprising the steps of:
(a) determining said patient's dose-adjusted nadir absolute neutrophil count (ANC) in the first cycle of said patient's chemotherapy schedule by the following calculation:
(observed nadir white blood cell (WBC) count)×(% of planned chemotherapy dose actually administered in said first cycle);
(b) determining said patient's dose-adjusted percent change in platelet count from day one to the dose-adjusted nadir platelet count in said first cycle of said patient's chemotherapy schedule by the following calculation: (((platelet count on day 1 of said first cycle)−(dose-adjusted nadir platelet count in said first cycle)) / (observed platelet count on day 1 of said first cycle))×100, wherein said dose-adjusted nadir platelet count is calculated as: (observed nadir platelet count in said first cycle)×(% of planned chemotherapy dose actually administered in said first cycle); and
(c) calculating the probability that said patient will receive a suboptimal chemotherapy dose comprising less than about 85% of the planned chemotherapy dose as: 1/(1+exp^{-(0.28-1.97×(dose-adjusted nadir ANC in said first cycle)+0.04×(dose-adjusted percent change in platelet count in said first cycle))}),
wherein said chemotherapy comprises administration of cyclophosphamide, doxorubicin, and 5-fluorouracil (CAF chemotherapy).

11. The method of claim 10, wherein said chemotherapy schedule comprises six 28-day cycles of CAF chemotherapy.

12. The method of claim 11, wherein each of said cycles of CAF chemotherapy comprises administration of 100 mg/m²/day of cyclophosphamide on days 1 through 14, administration of 30 mg/m²/day of doxorubicin on days 1 and 8, and administration of 500 mg/m²/day of 5-fluorouracil on days 1 and 8.

13. The method of claim 10, wherein said dose reduction is necessitated by excess myelotoxicity.

14. An instrument for predicting the probability of a patient requiring a significant dose reduction in adjuvant chemotherapy for breast cancer and/or predicting whether early treatment with a myeloid growth factor is warranted, said instrument comprising a means for calculating the probability that said patient will receive a suboptimal chemotherapy dose using said patient's dose-adjusted nadir absolute neutrophil count (ANC) in the first cycle of said patient's chemotherapy schedule and said patient's dose-adjusted percent change in platelet count from day one to the dose-adjusted nadir platelet count in said first cycle of said patient's chemotherapy schedule.

15. The instrument of claim 14, wherein said suboptimal dose comprises less than about 85% of the planned chemotherapy dose, wherein said probability is calculated as: 1/(1+exp^{-(0.28-1.97×(dose-adjusted nadir ANC in the first cycle of said patient's chemotherapy schedule)+0.04×(dose-adjusted percent change in platelet count from day one to the dose-adjusted nadir platelet count in said first cycle of said patient's chemotherapy schedule))}), wherein said dose-adjusted nadir ANC is calculated as: (observed nadir white blood cell (WBC) count)×(% of planned chemotherapy dose actually administered in said first cycle), wherein said dose-adjusted percent change in platelet count is calculated as: (((platelet count on day 1 of said first cycle)−(dose-adjusted nadir platelet count in said first cycle)) / (observed platelet count on day 1 of said first cycle))×100, and wherein said dose-adjusted nadir platelet count is calculated as: (observed nadir platelet count in said first cycle)×(% of planned chemotherapy dose actually administered in said first cycle).
